(19) United States
(12) Patent Application Publication
(10) Pub. No.: US 2020/0132841 A1
(43) Pub. Date: Apr. 30, 2020

(54) SYSTEMS AND METHODS FOR CONTROLLING AIRCRAFT BASED ON SENSED AIR MOVEMENT

(71) Applicant: A^3 by Airbus LLC, Sunnyvale, CA (US)

(72) Inventors: Zachary T. Lovering, Sunnyvale, CA (US); Arne Stoschek, Palo Alto, CA (US); Geoffrey C. Bower, Sunnyvale, CA (US)

(73) Assignee: A^3 by Airbus LLC, Sunnyvale, CA (US)

(21) Appl. No.: 16/627,591

(22) PCT Filed: Jun. 30, 2017
(86) PCT No.: PCT/US2017/040443

§ 371 Date: Dec. 30, 2019

(51) Int. Cl. G01S 17/58; B64C 13/16; B64D 31/06; G01S 17/933; G01S 17/95

(52) U.S. Cl. CPC G01S 17/58; B64C 13/16; G01S 17/95; G01S 17/933; B64D 31/06

(57) ABSTRACT

A monitoring system (5, 205) for an aircraft (10) has sensors (20, 30) that are used to sense the air movement around the aircraft. The monitoring system may use information from the sensors to estimate the effects of the air movement on the aircraft and to determine how to control components of the aircraft, such as flight control surfaces and a propulsion system, to compensate for such effects. The monitoring system may also assess aircraft performance based on the air movement information and provide control inputs for improving such performance. It is also possible for the monitoring system to determine more optimal flight paths for avoiding collision threats based on the air movement information.

### CROSS REFERENCE TO RELATED APPLICATION

This application claims priority to International Application PCT/US2017/040443, entitled “SYSTEMS AND METHODS FOR CONTROLLING AIRCRAFT BASED ON SENSED AIR MOVEMENT” and filed on Jun. 30, 2017, which is incorporated herein by reference.

### BACKGROUND

Aircraft may encounter a wide variety of atmospheric conditions during flight, such as high winds, rain, hail, freezing temperatures or other weather conditions. Wind gusts can place stress on the aircraft and can affect passenger comfort, as well as the controllability or performance of the aircraft. Strong wind gusts in some cases can also cause damage to the aircraft. The effects of wind gusts are further amplified for small aircraft, where even minor winds and atmospheric variations have larger effects on the aircraft.

Information about wind gusts in an aircraft's flight path may allow for an aircraft to avoid strong gusts if the information is accurate and is received far enough in advance. Some aircraft receive gust information from sources such as weather reports, transmissions from other aircraft, or operator observations. Even though various sources may be capable of providing information about gusts, an aircraft may not have access to such information in all situations and such information may not indicate the precise location of the gusts.

### BRIEF DESCRIPTION OF THE DRAWINGS

The disclosure can be better understood with reference to the following drawings. The elements of the drawings are not necessarily to scale relative to each other, emphasis instead being placed upon clearly illustrating the principles of the disclosure.

FIG. 1 depicts a three-dimensional perspective view of an aircraft having an aircraft monitoring system in accordance with some embodiments of the present disclosure.

FIG. 2 is a block diagram illustrating various components of an aircraft monitoring system in accordance with some embodiments of the present disclosure.

FIG. 3 is a block diagram illustrating a data filter in accordance with some embodiments of the present disclosure.

FIG. 4 is a block diagram illustrating a sense and avoid element in accordance with some embodiments of the present disclosure.

FIG. 5 is a block diagram illustrating an aircraft controller in accordance with some embodiments of the present disclosure.

FIG. 6 is a flow chart illustrating a method for compensating for air movement in accordance with some embodiments of the present disclosure.

FIG. 7 is a flow chart illustrating a method for enhancing an aerodynamic performance of a wing in accordance with some embodiments of the present disclosure.

FIG. 8 depicts a three-dimensional perspective view of aircraft having aircraft monitoring systems operating in an urban environment in accordance with some embodiments of the present disclosure.

### DETAILED DESCRIPTION

The present disclosure generally pertains to systems and methods for controlling vehicles. In some embodiments, an aircraft includes an aircraft monitoring system having sensors that are used to sense air movement for use in making control decisions, such as flight path selection and attitude and speed adjustments. As an example, a light detection and ranging (LIDAR) sensor may be used to detect movement of air particles around the aircraft to determine air velocity at multiple points in the vicinity of the aircraft. Based on sensed air movement, the system may identify regions of strong wind gusts and also determine attributes about the air movement, such as its likely effect on aircraft performance. The aircraft may then be controlled to avoid strong gusts or counteract the air movement based on the sensor data.

In other examples, the system can control the aircraft in other ways based on air movement. As an example, the system may change a heading of the aircraft to take better advantage of tailwinds or help to avoid or mitigate the effects of a headwind. The system may also control the aircraft to make improved path selection decisions in sense and avoid applications. As an example, based on sensed air movement, the system may more accurately determine an escape envelope (e.g., a range of possible paths) for avoiding a sensed object that may be a collision threat to the aircraft. Such escape envelope may take into account the performance characteristics of the aircraft as well as the effect of the sensed air movement on such performance characteristics. The escape envelope may also take into account strong gusts indicated by the sensed air movement for path selection (e.g., define the escape envelope to avoid strong wind gusts). Other uses of the sensed air movement are possible in yet other examples. Exemplary techniques for defining escape envelopes and selecting paths to avoid collision threats are further described in U.S. Patent Application No. 62/503,311, which is incorporated by reference herein in its entirety. As noted therein, the system also can use information about the aircraft, such as its capabilities (e.g., maneuverability), energy budget, or operating status, to create the escape envelope.

In some embodiments, as the aircraft encounters air movement, the system can use information about the sensed air movement to control resources of the aircraft to counteract such air movement. For example, the system can use sensor data indicative of the movement of air approaching the aircraft and determine an expected effect that the air movement will have on the aircraft. The system may then compensate for the effects of sensed air movement on the aircraft by controlling the aircraft's propulsion system, flight control surfaces, or otherwise as it encounters the air movement. For example, if the system determines that a gust traveling upward (an updraft) will force the aircraft upward, the system may control the aircraft to pitch the aircraft's nose downward to counteract the gust. Such compensation may help to reduce the effects of the air movement by keeping the aircraft on a desired flight path and also may enhance passenger comfort. The system can control resources of the aircraft to compensate for air movement as may be desired.

In another example, the system may use sensor data indicative of air movement to determine attributes indicative of aircraft performance and may make control decisions (such as adjusting one or more flight control surfaces or propulsion devices) based on the determined attributes in an effort to improve the aircraft's performance. As an example, the system may analyze air movement behind the aircraft (e.g., in the downwash of one or more wings) to determine at least one parameter, such as induced drag, indicative of wing performance. Based on such parameter, the system may make one or more control decisions, such as an adjustment to attitude or airspeed, in an effort to optimize the parameter or other performance characteristic of the aircraft. For example, using a parameter indicative of induced drag, the system may infer the lift distribution over a wing and then provide control inputs in an effort to achieve a more ideal lift distribution taking into account current operating conditions, such as airspeed and altitude. Thus, over time as the aircraft continues to make adjustments as operating conditions and air movement change, the aircraft operates more efficiently thereby helping to enhance range.

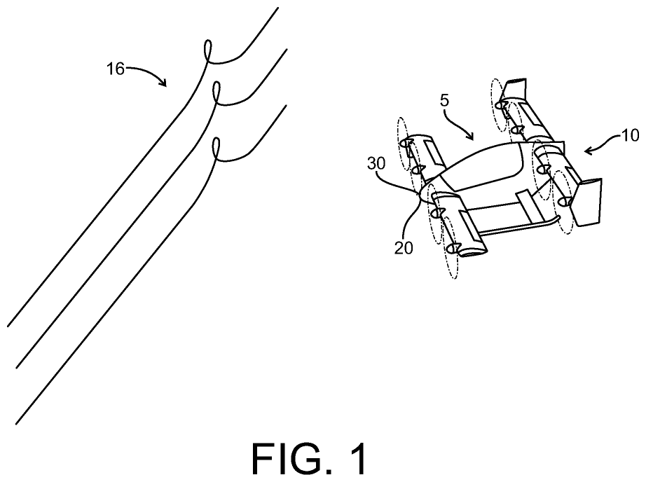

FIG. 1 depicts a three-dimensional perspective view of an aircraft 10 having an aircraft monitoring system 5 in accordance with some embodiments of the present disclosure. The system 5 is configured to use sensors 20, 30 to detect air movement, such as gusts 16, within a vicinity of the aircraft 10. The system 5 is also configured to determine information about the aircraft 10 and its route. The system 5 can determine a path for the aircraft 10 to follow that will avoid encountering strong gusts, select a path that will help to optimize vehicle performance in view of the air movement, or control the aircraft 10 to counteract the effects of the air movement, such as by controlling propulsion, flight control surfaces, or other resources of the aircraft 10 to reduce effects of air movement on the aircraft 10 or its path (e.g., reduce turbulence on the aircraft 10). In addition, the system 5 may be configured to generally improve performance of the aircraft 10 during operation based on sensed air movement, such as by achieving desired aerodynamic characteristics (e.g., lift, induced drag, etc.), thereby enhancing energy efficiency and extending range.

As known in the art, turbulence generally refers to air movement that causes abrupt changes to the velocity of aircraft as the aircraft passes through such air movement. Turbulence can cause an aircraft to deviate from its desired flight path or attitude and can also cause passenger discomfort. Turbulence can occur in the form of wind gusts, such as updrafts and downdrafts, or other types of wind shear.

The aircraft 10 may be of various types, but in the embodiment of FIG. 1, the aircraft 10 is depicted as a self-piloted vertical takeoff and landing (VTOL) aircraft 10. The aircraft 10 may be configured for carrying various types of payloads (e.g., passengers, cargo, etc.). Although the embodiments disclosed herein generally concern functionality ascribed to aircraft monitoring system 5 as implemented in an aircraft, in other embodiments, systems having similar functionality may be used with other types of vehicles 10, such as automobiles or watercraft. As an example, a monitoring system may be used onboard a boat or ship for sensing movement of the water through which the boat or ship is moving and make control decisions based on such movement, as described herein for air.

The aircraft 10 may be manned or unmanned, and may be configured to operate under control from various sources. In the embodiment of FIG. 1, the aircraft 10 is self-piloted (e.g., autonomous). As an example, the aircraft 10 may be configured to perform autonomous flight by following a predetermined route to its destination. The aircraft monitoring system 5 is configured to communicate with a flight controller (not shown in FIG. 1) on the aircraft 10 to control the aircraft 10 as described herein. In other embodiments, the aircraft 10 may be configured to operate under remote control, such as by wireless (e.g., radio) communication with a remote pilot. Various other types of techniques and systems may be used to control the operation of the aircraft 10. Exemplary configurations of an aircraft are disclosed by PCT Application No. 2017/018135, which is incorporated herein by reference, and PCT Application No. 2017/040413, entitled “Vertical Takeoff and Landing Aircraft with Passive Wing Tilt” and filed on even date herewith, which is incorporated herein by reference. In other embodiments, other types of aircraft may be used.

In the embodiment of FIG. 1, the aircraft 10 has one or more sensors 20 of a first type (e.g., cameras, LIDAR, etc.) for monitoring space around aircraft 10, and one or more sensors 30 of a second type (e.g., radar, LIDAR, etc.) for providing redundant sensing of the same space or sensing of additional spaces. In some embodiments, the sensors 20, 30 may provide sensor data indicative of air movement around the aircraft 10. As an example, the sensors 20, 30 may be configured to scan the area around the aircraft 10 to detect air movement (e.g., air velocity at various points around the aircraft 10). Such sensor data may then be processed to determine how to control the aircraft 10 to compensate for the effects of air movement or for operating the aircraft 10 more efficiently. In addition, any of the sensors 20, 30 may comprise any optical or non-optical sensor for detecting the presence of objects, such as a camera, an electro-optical or infrared (EO/IR) sensor, a light detection and ranging (LIDAR) sensor, a radio detection and ranging (radar) sensor, or other sensor type. A sensor 20, 30 may be configured both for scanning the area around aircraft 10 to detect particle movement that is indicative of air motion and for sensing objects that may present a collision threat to the aircraft 10. The sensor 20, 30 may perform various operations to achieve the desired sensing, such as rotating, changing position, performing various redundant sensing, or otherwise. Exemplary techniques for sensing objects using sensors 20, 30 are described in PCT Application No. PCT/US2017/25592 and PCT Application No. PCT/US2017/25520, each of which is incorporated by reference herein in its entirety.

In some embodiments, the system 5 can be configured to detect air movement using sensor data indicative of motion of particles in the air, such as dust, pollutants, moisture particles, etc. Movement of airborne particles may be indicative of a region of turbulence 16. For example, movement of airborne particles may correspond to the movement of air carrying the particles. Thus, by monitoring motion of airborne particles, the system 5 may determine motion of the air (e.g., velocity) associated with the particles.

In some embodiments, to detect particle movement, the system 5 may receive and process sensor data from a sensor 20, 30, such as a LIDAR sensor, configured to scan the area around the aircraft 10. For illustrative purposes, it will be assumed hereafter the sensors 20, 30 are implemented as LIDAR sensors unless otherwise noted. However, it should be emphasized that other sensors for sensing air movement may be used in other embodiments.

The system 5 may use data from the sensors 20, 30 to identify airborne particles and assess the movement of such particles to determine air velocity at such points. As will be described in more detail below, the system 5 may be configured to filter sensor data (e.g., optical returns from lasers of a LIDAR sensor) to separate returns from large objects and returns from smaller objects, such as airborne particles.

In addition to detecting air movement, the system 5 can also make determinations or estimations about performance characteristics of the aircraft 10 based on such air movement. For example, as will be described in more detail below, the system 5 may estimate a parameter indicative of aerodynamic performance of at least one wing, such as induced velocity or induced drag, and use the parameter to make control adjustments for achieving more optimal performance.

The system 5 also can determine whether the aircraft 10 should attempt to avoid a strong wind gust 16, or attempt to compensate for its effects (e.g., based on an estimation of a velocity of air flow associated with gust 16). For example, for a strong gust (e.g., a gust associated with a change in air velocity above a threshold), the system 10 may attempt to avoid the wind gust by selecting a flight path that does not intersect with the gust 16. Alternatively, rather than avoiding a gust 16, the system 5 may compensate for the gust 16 by controlling the aircraft 10 to counteract its effects as it approaches and encounters the gust 16.

Note that, in addition to other information described in U.S. Pat Application No. U.S. Patent Application No. 62/503,311, system 5 may use information about air movement when generating an escape envelope (not specifically shown in FIG. 1). As an example, the system 5 may note a location of a strong gust 16 and adjust the shape of the escape envelope to account for the gust 16. System 5 may further select a flight path within the escape envelope that avoids not only an object sensed in sensor data from sensors 20, 30, but also that avoids the strong gust 16 or reduces or compensates for its effects on the aircraft 10. The escape envelope may have various shapes to account for sensed air movement. Moreover, the aircraft monitoring system 5 may use information about the aircraft 10 to determine an escape envelope (not specifically shown in FIG. 1) that represents a possible range of paths that aircraft 10 may safely follow (e.g., within a pre-defined margin of safety or otherwise) to avoid a collision threat, such as another aircraft, terrain, etc. The system 5 may then select a flight path (e.g., escape path) within the envelope for the aircraft 10 to follow. In identifying the escape path (not specifically shown), the system 5 may use information (e.g., velocity) from the sensors 20, 30 about the sensed air movement. The escape path may also be defined such that the aircraft 10 will return to the approximate heading that the aircraft 10 was following before it performed evasive maneuvers.

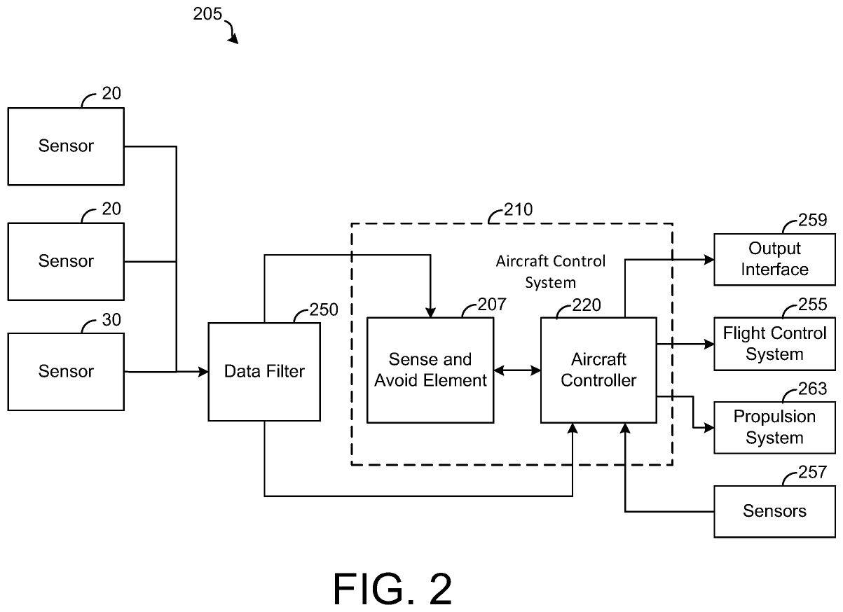

FIG. 2 is a block diagram illustrating various components of an aircraft monitoring system 205 in accordance with some embodiments of the present disclosure. As shown by FIG. 2, the aircraft monitoring system 205 may include a plurality of sensors 20, 30, a data filter 250, and an aircraft control system 210 having a sense and avoid element 207 and an aircraft controller 220. Although particular functionality may be ascribed to various components of the aircraft monitoring system 205, it will be understood that such functionality may be performed by one or more components of the system 205 in some embodiments. In addition, in some embodiments, components of the system 205 may reside on the aircraft 10 or otherwise, and may communicate with other components of the system 205 via various techniques, including wired (e.g., conductive), optical, or wireless communication. Further, the system 205 may comprise various components not specifically depicted in FIG. 2 for achieving the functionality described herein and generally performing sensing operations and aircraft control.

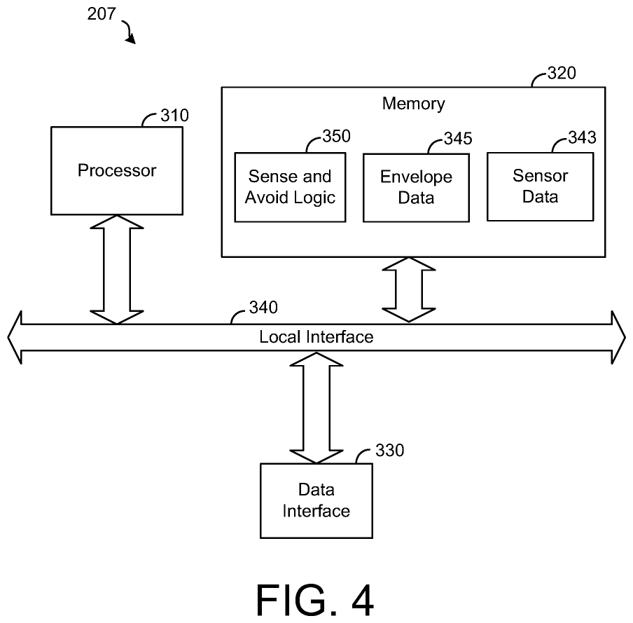

The sense and avoid element 207 of the aircraft monitoring system 205 may perform processing of sensor data and air movement data received from aircraft controller 220 to determine a path for the aircraft 10 to follow. In some embodiments, as shown by FIG. 2, the sense and avoid element 207 may be coupled to data filter 250 to receive sensor data from each sensor 20, 30, process the sensor data from the sensors 20, 30, and provide signals to the aircraft controller 220. The sense and avoid element 207 may be various types of devices capable of receiving and processing sensor data from sensors 20, 30 and information from the aircraft controller 220. The sense and avoid element 207 may be implemented in hardware or a combination of hardware and software/firmware. As an example, the sense and avoid element 207 may comprise one or more application-specific integrated circuits (ASICs), field-programmable gate arrays (FPGAs), microprocessors programmed with software or firmware, or other types of circuits for performing the described functionality. An exemplary configuration of the sense and avoid element 207 will be described in more detail below with reference to FIG. 4.

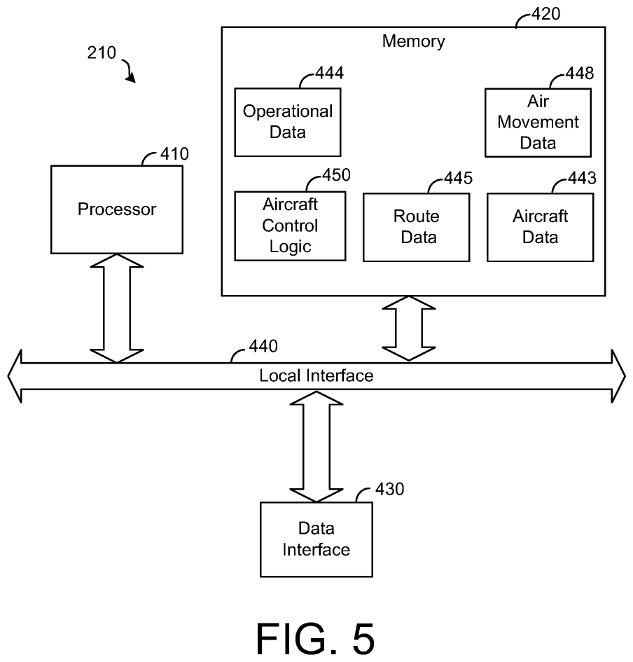

As shown by FIG. 2, the aircraft controller 220 may be coupled to the sense and avoid element 207 and data filter 250. The aircraft controller 220 may be of various types capable of receiving and processing data from the sense and avoid element 207 and data filter 250, and may be implemented in hardware or a combination of hardware and software. As an example, the aircraft controller 220 may comprise one or more application-specific integrated circuits (ASICs), field-programmable gate arrays (FPGAs), microprocessors programmed with software or firmware, or other types of circuits for performing the described functionality. As will be described in more detail hereafter, based on sensed air movement within or near the expected path of the aircraft 10, the controller 220 may be configured to control the resources of aircraft 10 (e.g., actuators and the propulsion system) to change the velocity (speed and/or direction) or attitude of the aircraft 10. As an example, the aircraft controller 220 may control the aircraft 10 in an effort to counteract the effects of the sensed air movement or enhance a performance of the aircraft 10. An exemplary configuration of the aircraft controller 220 will be described in more detail below with reference to FIG. 5.

The aircraft controller 220 may be coupled to various resources of aircraft 10 for controlling various operations of aircraft 10. In some embodiments, the aircraft controller 220 may perform suitable control operations of the aircraft 10 by providing signals or otherwise controlling a flight control system 255, which may include a plurality of flight control surfaces (not specifically shown), such as one or more ailerons, flaps, elevators, or rudders. The flight control system 255 may also include actuators (not specifically shown) for controlling the flight control surfaces as desired. The aircraft controller 220 may also control a propulsion system 263, as will be described in more detail below, to flight operations as may be desired.

One or more aircraft sensors 257 may monitor operation and performance of various components of the aircraft 10 and may send feedback indicative of such operation and performance to the controller 220. As an example, the sensors 257 may include one or more altimeters, airspeed indicators, heading indicators, turn-and-slip indicators, vertical speed indicators, or other types of sensors used for monitoring flight. If desired, the aircraft controller 220 may perform redundant sensing of the same flight parameters based on sensed air movement. As an example, the aircraft controller 220 may be coupled to an output interface 259, which may include one or more graphical displays or other types of interfaces for providing outputs (e.g., visual or audio indications) indicative of the sensed parameters, such as airspeed, turn and slip, angle of attack of at least one wing, or sideslip angle.

In addition, the aircraft controller 220 may compare flight parameters measured by the sensors 257 to flight parameters determined by the aircraft controller 220 based on sensed air movement to provide a warning when there is a discrepancy above a threshold. As an example, if the airspeed derived from air movement sensed by a sensor 20, 30 is different than the airspeed sensed by a sensor 257 (e.g., a pitot tube) by at least a threshold amount, the aircraft controller 220 may provide a warning via the output interface 259 or otherwise to warn of the discrepancy. In another example, if the angle of attack derived from air movement sensed by a sensor 20, 30 comes within a predefined range indicating that a stall is imminent, the aircraft controller 220 may provide a stall warning. Various other types of flight parameters may be monitored by the aircraft controller 220 based on the air movement sensed by a sensor 20, 30 (e.g., a LIDAR sensor) in other embodiments.

As shown by FIG. 2, the aircraft controller 220 may be coupled to and control a propulsion system 263 of the aircraft 10. The propulsion system 263 may comprise various components, such as engines and propellers, for providing propulsion or thrust to the aircraft 10. The aircraft controller 220 may provide one or more signals for controlling the propulsion system 220, such as a signal for controlling the rotational speed of one or more propellers as may be desired.

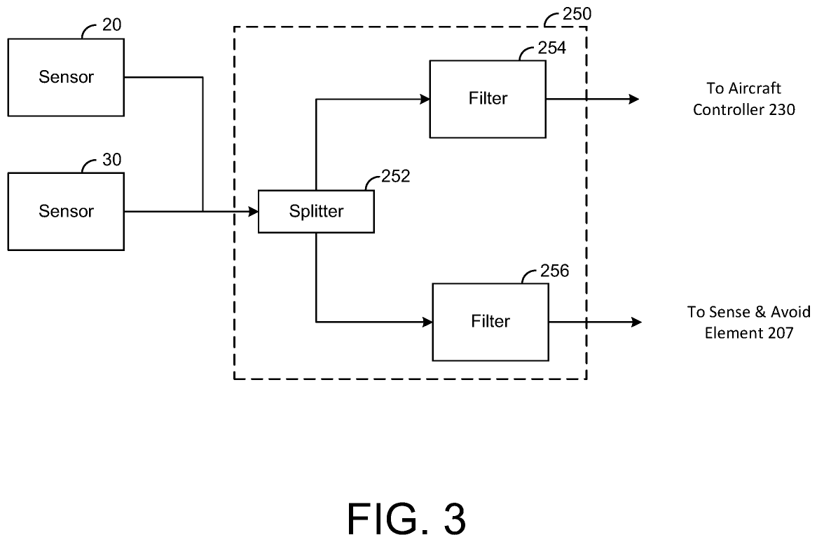

FIG. 3 depicts a data filter 250 in accordance with some embodiments of the present disclosure. As shown by FIG. 3, the data filter 250 is coupled to receive sensor data from the sensors 20, 30 and provide filtered sensor data to each of the sense and avoid element 207 and the aircraft controller 220. As shown by FIG. 3, the data filter 250 may be coupled to a splitter 252 to provide the sensor data to each of a plurality of filters 254, 256. Although a single splitter 252 is depicted in FIG. 3 for simplicity, various numbers of splitters are possible for achieving the functionality described herein.

Each filter 254, 256 coupled to splitter 252 may be implemented in hardware, software, or various combinations thereof, and may be any of various types of filters for performing desired filtering of sensor data received from the splitter 252. The filters 254, 256 may be configured as high-pass, low-pass, or other types of filters, and may comprise additional components for achieving the functionality ascribed to filters 254, 256 (e.g., FPGAs, ASICs, etc.). The filters 254, 256 may be configured for filtering data (e.g., removing, discarding, muting, reducing, etc.) that is not of a desired type from the sensor data received from the splitter 252 and providing the filtered data to one or more aircraft components, such as sense and avoid element 207 and aircraft controller 220. For example, the filter 254 may be configured to filter data from the sensors 20, 30 to remove data indicative of large objects (e.g., objects having a dimension above a predefined threshold), such as other aircraft, birds, buildings, terrain, and other types of objects that may pose a collision threat to the aircraft 10, and provide the filtered data to the aircraft controller 220. Thus, the filtered data from the filter 254 indicates (e.g., provides information about size and location) small airborne-particles, such as dust, vapor, small debris, pollutants, and other particles that may be carried by air movement. The aircraft controller 220 may use such filtered data to determine air movement (e.g., velocity at various points within a vicinity of the aircraft 10) for making control decisions about the aircraft (e.g., controlling velocity or attitude).

The filter 256 may be configured to filter data from the sensors 20, 30 to remove data indicative of small particles (e.g., objects having a dimension below a predefined threshold), such as dust, vapor, small debris, and pollutants, and provide the filtered data to the sense and avoid element 207. Thus, the filtered data from the filter 256 indicates (e.g., provides information about size and location) large objects, such as other aircraft, birds, buildings, terrain, and other types of objects that may pose a collision threat to the aircraft 10. The sense and avoid element 207 may use the filtered data to identify objects that may be collision threats to the aircraft 10 for making control decisions to avoid such collision threats. Although two filters are depicted for simplicity in FIG. 3, it will be understood that various numbers of filters for filtering various types of desired data received from sensors 20, 30 are possible in other embodiments.

FIG. 4 depicts a sense and avoid element 207 in accordance with some embodiments of the present disclosure. As shown by FIG. 4, the sense and avoid element 207 may include one or more processors 310, memory 320, a data interface 330 and a local interface 340. The processor 310 may be configured to execute instructions stored in memory in order to perform various functions, such as processing of sensor data received from the data filter 250 (FIGS. 1, 2) and envelope data from the aircraft controller 220 (FIG. 2). The processor 310 may include a central processing unit (CPU), a digital signal processor (DSP), a graphics processing unit (GPU), an FPGA, other types of processing hardware, or any combination thereof. Further, the processor 310 may include any number of processing units to provide faster processing speeds and redundancy. The processor 310 may communicate to and drive the other elements within the sense and avoid element 207 via the local interface 340, which can include at least one bus. Further, the data interface 330 (e.g., ports or pins) may interface components of the sense and avoid element 207 with other components of the system 205, such as the sensors 20, 30, the data filter 250, and the aircraft controller 220.

As shown by FIG. 4, the sense and avoid element 207 may comprise sense and avoid logic 350, which may be implemented in hardware, software, firmware or any combination thereof. In FIG. 4, the sense and avoid logic 350 is implemented in software and stored in memory 320 for execution by the processor 310. However, other configurations of the sense and avoid logic 350 are possible in other embodiments.

Note that the sense and avoid logic 350, when implemented in software, can be stored and transported on any computer-readable medium for use by or in connection with an instruction execution apparatus that can fetch and execute instructions. In the context of this document, a “computer-readable medium” can be any means that can contain or store code for use by or in connection with the instruction execution apparatus.

The sense and avoid logic 350 is configured to receive data from the data filter 250 (FIG. 2) for use in assessing whether there is a collision risk between the object and aircraft 10. As described more fully in U.S. Patent Application No. 62/503,311, the sense and avoid logic 350 is configured to identify a collision threat based on the received data and notify the aircraft controller 220 of each identified collision threat. The sense and avoid logic 350 can classify an identified object (e.g., determine an object type) and provide information about the object such as the object's velocity, classification, and possible flight performance to the controller 220. As described below, the controller 220 can use such information in generating and providing an escape envelope to sense and avoid element 207. Such escape envelope defines a range of possible paths for avoiding each identified collision threat.

Note that, in some embodiments, the sense and avoid logic 350 may identify objects using sensor data filtered by the filter 256 (FIG. 3). As noted above, data received from the filter 256 may include sensor data that has been filtered to remove data that is indicative of small airborne particles (e.g., dust, vapor, etc.). The data provided to the sense and avoid element 207 may thus be indicative of objects that may present a collision threat to the aircraft 10 or other objects that may move in a manner that is not necessarily indicative of motion of air around the object. This filtered sensor data may be provided to the sense and avoid element 207 and may be stored as sensor data 343 for use by the sense and avoid logic 350. The sense and avoid logic 350 is configured to use the sensor data 343 to perform object detection, classification, assessment and other operations as described herein and in documentation incorporated herein by reference.

Note that the sense and avoid element 207 is configured to receive data “envelope data,” (not specifically shown in FIG. 4) indicative of an escape envelope from the aircraft controller 220. In some embodiments, the escape envelope provided from the aircraft controller 220 may be defined to account for the presence of air movement. As an example, the escape envelope may be defined to exclude paths that would take the aircraft through regions of strong gusts (e.g., gusts having velocity changes above a certain threshold). The sense and avoid logic 350 is configured to use the escape envelope to select an escape path within the envelope and propose the selected escape path to the aircraft controller 220, which may then control the aircraft 10 to fly along the selected escape path. By excluding an area of a strong gust from the escape envelope, as described above, the sense and avoid element 207 is prevented from selecting an escape path that passes through such area. In addition, as will be described in more detail below, the shape of the escape envelope may be affected by sensed air movement to account for the effects that wind may have on the performance capabilities of the aircraft 10.

The sense and avoid logic 350 is configured to process sensor data 343 and envelope data 345 dynamically as new data become available (e.g., from filter 256 of data filter 250). As an example, when the sense and avoid element 207 receives new data from data filter 250 or aircraft controller 220, the sense and avoid logic 350 processes the new data and updates any determinations previously made as may be desired. The sense and avoid logic 350 thus may update sensor data 343 and information about an object (e.g., location, velocity, threat envelope, etc.) when it receives new information from data filter 250. In addition, the sense and avoid logic 350 may receive an updated escape envelope 25 from aircraft controller 220 and may use the updated information to select a new escape path to propose to aircraft controller 220 within the updated escape envelope. Thus, the sensor data 343 and the envelope data (not specifically shown) are repetitively updated as conditions change.

FIG. 5 depicts an aircraft controller 220 in accordance with some embodiments of the present disclosure. As shown by FIG. 5, the aircraft controller 220 may include one or more processors 410, memory 420, a data interface 430 and a local interface 440. The processor 410 may be configured to execute instructions stored in memory in order to perform various functions, such as processing of aircraft data 443 and route data 445. The processor 410 may include a central processing unit (CPU), a digital signal processor (DSP), a graphics processing unit (GPU), an FPGA, other types of processing hardware, or any combination thereof. Further, the processor 410 may include any number of processing units to provide faster processing speeds and redundancy. The processor 410 may communicate to and drive the other elements within the aircraft controller 220 via the local interface 440, which can include at least one bus. Further, the data interface 430 (e.g., ports or pins) may interface components of the mission processing element 210 with other components of the system 5, such as the sense and avoid element 207 and the data filter 250.

As shown by FIG. 5, the aircraft controller 220 may comprise aircraft control logic 450, which may be implemented in hardware, software, firmware or any combination thereof. In FIG. 5, the aircraft control logic 450 is implemented in software and stored in memory 420 for execution by processor 410. However, other configurations of the aircraft control logic 450 are possible in other embodiments. Note that the aircraft control logic 450, when implemented in software, can be stored and transported on any computer-readable medium for use by or in connection with an instruction execution apparatus that can fetch and execute instructions.

The aircraft control logic 450 may be configured to process information, such as aircraft data 443, operational data 444, route data 445, and air movement data 448 to detect and compensate for air movement, as well as generate an escape envelope and provide it to the sense and avoid element 207, as described above.

The aircraft data 443 includes information about the performance characteristics associated with the aircraft 10, such as its various speeds (e.g., never-to-exceed speed, normal operating speeds for various flight configurations, stall speed, etc.), maneuverability, power requirements, and other information useful in determining the aircraft's capabilities and flight performance. In particular, aircraft data 443 may include information about aerodynamic performance of the aircraft 10, such as ideal (e.g., experimental or theoretical) aerodynamic conditions. The aircraft data 443 may further indicate various information about the aircraft 10, such as weight of passengers or cargo, whether any passengers are on board the aircraft 10, or other information that might limit or otherwise affect the flight performance characteristics of the aircraft 10. Note that the aircraft data 443 may indicate different characteristics for different flight configurations of the aircraft 10. As an example, the performance characteristics of the aircraft 10 when all components, such as propellers or engines, are operating is likely different after a failure of one or more components (e.g., propellers), and the aircraft 443 data may indicate performance of the aircraft 10 when it is experiencing certain component failures. The aircraft data 443 may be predefined based on manufacture specifications or testing of the aircraft 443 prior to operation, associated with the aircraft in memory, and updated based on measured or sensed data received at the aircraft controller 220 during flight.

The operational data 444 includes information about the current operating conditions of the aircraft 10, such as the aircraft's current heading, speed, altitude, throttle settings, pitch, roll, yaw, fuel level or battery power, and other operational information. Operational data 444 also may include information about current (e.g., measured by a sensor of the system 205) aerodynamic conditions for various times or time periods during flight of the aircraft 10. As an example, aircraft data 443 may include information about pressure, lift, drag, or other aerodynamic forces present on various components of the aircraft 10 (e.g., wings, propellers, fuselage, engine cowlings, etc.) at a given time or for a given time period, as well as information about induced drag or induced velocity (e.g., a distribution or profile) for the various components of the aircraft 10. Such information may be received by the aircraft controller 220 from one or more aircraft sensors. The operational data 444 may also include information about current orientations of components of the aircraft 10, such as flight control surfaces (ailerons, elevators, rudders, flaps, etc.), propellers of the propulsion system, wing configuration, or other components of aircraft 10 having variable or adjustable configurations. As an example, operational data 444 may include information about a pitch of a wing of the aircraft 10, trim of a propeller of a propulsion system of the aircraft 10, or otherwise.

The route data 445 includes information about the route that the aircraft 10 is flying. As an example, the route data 445 may define the waypoints to be used for navigating the aircraft 10 to its desired destination, and the route data 445 may indicate various obstacles or objects (e.g., buildings, bridges, towers, terrain, etc.) along the route that may be used for collision avoidance or navigation. The route data 445 may also indicate the locations of restricted airspace (e.g., airspace through which the aircraft 10 is not permitted to fly). For example, in some embodiments, the route data 445 may include information about the locations of gusts 16 detected by the aircraft control logic 450. The route data 445 may include an identifier indicating a restriction preventing the aircraft 10 from navigating to a region where a strong gust 16 is detected or likely to occur. The route data 445 may be updated by the aircraft control logic 450 based on communications with remote systems for air traffic control or other purposes. As an example, the aircraft 10 may be assigned a block or corridor of airspace in which the aircraft 10 must remain thereby limiting the possible routes that the aircraft 10 may take to avoid strong gusts 16 or collision threats. Further, the route data 445 may include information indicative of a path that will allow the aircraft 10 to maintain an essentially straight flight path to its destination or next waypoint in route data 445 when compensating for turbulence 16. The route data 445 may be predefined and, if desired, updated by the aircraft controller 220 as information about the route is sensed, such as new gusts 16, new collision threats along the route, or new air traffic control instructions.

Air movement data 448 includes information about air motion around the aircraft 10, such as may be determined by the aircraft control logic 450 using data from sensors 20, 30 (e.g., from filter 254 of data filter 250). The air movement data 448 may define motion of airborne particles around the aircraft 10 based on filtered sensor data indicative of airborne particles. For example, information in air movement data 448 indicative of movement of airborne particles may be associated with various types of air motion (e.g. wind gusts, updrafts, downdrafts, downwash aft of the aircraft 10, etc.) around the aircraft 10 that the aircraft 10 is likely to encounter. Air movement data 448 can define locations of airborne particles in sensor data with regions or spaces around the aircraft 10 for use by the aircraft control logic 450 in generating a three-dimensional map of air movement in the space around the aircraft 10. The aircraft control logic 450 can store such three-dimensional map in air movement data 448, and update the map from time-to-time as new data becomes available affecting the map. The air movement data 448 can further include information, such as a table or other information defining a relationship between detected air movement and flight maneuvers available to the aircraft 10 to compensate for the air movement (e.g., based on information such as aircraft data 443).

In some embodiments, aircraft control logic 450 may use the air movement data 448 to generate an escape envelope indicating available routes for an aircraft 10 to fly, such as when the aircraft 10 is attempting to avoid an object. The characteristics of the escape envelope may be limited by various factors, including airspace restrictions or limitations on aircraft performance (e.g., based on aircraft data 443 and operating conditions 444). For example, the logic 450 can note a region where the aircraft 10 will encounter a strong gust 16 and limit the escape envelope to exclude paths that would take the aircraft 10 through the region, thereby avoiding turbulence resulting from the strong gust 16. In some embodiments, the escape envelope may be modified to account for impacts of the air movement on the aircraft's performance (e.g., based on air movement data 448, updated aircraft data 443, and operational data 444, as described further below).

As an example, in defining the escape envelope, the aircraft control logic 450 may take into account the performance characteristics of the aircraft 10, as indicated by the aircraft data 443, and the effects of air movement on such performance characteristics. In this regard, air movement (e.g., winds or turbulence) may limit the rate at which an aircraft 10 is capable of turning, climbing, or descending thereby changing the range of paths that the aircraft 10 is capable of flying relative to an example in which there is no movement of the air relative to earth. Thus, taking into account air movement, as indicated by the air movement data 448, changes the escape envelope generated by the aircraft control logic 450 thereby providing a more accurate escape envelope in view of the actual air movement conditions at and around the location of the aircraft 10.

The aircraft control logic 450 also may be configured to use the air movement data 448 to make control decisions for compensating for the air movement. When the aircraft 10 does encounter a gust 16, the aircraft control logic 450 may attempt to control the aircraft 10 based on the sensed air movement to counteract the effects of the gust 16. As an example, the aircraft control logic 450 may determine a parameter indicative of the air movement, such as a force or velocity of the air movement, and based on such parameter determine a sufficient control input to cause the aircraft 10 to counteract the air movement thereby compensating for the effects of the sensed air movement on a performance of the aircraft 10. As an example, if the aircraft control logic 450 determines that the aircraft 10 is entering an area of a significant downdraft, the aircraft control logic 450 may pitch the aircraft 10 upward in an effort to generate more lift for reducing a downward change to the aircraft's flight path caused by the downdraft. In addition, the aircraft control logic 450 may increase propeller speed to increase lift in an effort to counteract the effects of the downdraft. Notably, the air movement may be detected before the aircraft 10 reaches it, and the control input may be provided as the aircraft 10 encounters the air movement or even slightly before the air movement is encountered in anticipation of the oncoming change in air velocity as may be desired. Other types of control input are possible depending on the estimated effects of the sensed air movement.

In some embodiments, the aircraft control logic 450 is configured to analyze air movement based on the air movement data 448 and to control aircraft components to optimize aircraft performance. For example, based on the air movement data 448, the aircraft control logic 450 can estimate aerodynamic forces that the aircraft 10 is experiencing and make control adjustments based on such estimations. In this regard, air movement (particularly strong updrafts, downdrafts, and winds) can have a material effect on aerodynamic forces (e.g., lift and induced drag) and force distributions across airfoils (e.g., lift distribution). Based on the air movement data 448, it is possible for the logic 450 to estimate parameters indicative of the aerodynamic forces that the aircraft 10 is experiencing or will experience and determine how to control the aircraft 10 (e.g., adjust attitude or propulsion) in order to achieve more optimal flight performance. By achieving more efficient flight along a route, the range of the aircraft 10 can be significantly extended. There are several techniques that can be used to determine the appropriate control inputs for optimizing the flight characteristics and performance of the aircraft 10 based on air movement. For illustrative purposes, some exemplary techniques will be described in more detail below, but it should be emphasized that various changes and modifications to these techniques are possible.

In this regard, as known in the art, an airfoil generating lift produces a downwash that is based on the lift characteristics of the airfoil. The aircraft control logic 450 based on the air movement data 448 is configured to analyze the downwash from at least one wing to determine at least one aerodynamic parameter indicative of the wing's performance. As an example, within a wing's downwash aft of the aircraft 10, the aircraft control logic 450 may measure induced velocity perpendicular to the aircraft's direction of motion to provide an estimation of induced drag. Based on induced drag, the aircraft control logic 450 may infer the lift distribution across the wing and then provide control inputs, such as attitude adjustments or adjustments to thrust (e.g., propeller speed), in order to provide a more optimal lift distribution for the aircraft's current operating conditions and thereby improve the performance of the wing.

As an example, the aircraft data 443 may store information indicating ideal lift distributions for various sets of operating conditions, such as airspeed and altitude. When the aircraft control logic 450 infers the current lift distribution based on analysis of the air movement data 448, the aircraft control logic 450 may search the aircraft data 443 for information indicative of the wing's ideal lift distribution for the aircraft's current operating conditions, such as the altitude and airspeed, as indicated by the aircraft's sensors 257. Based on the wing's current lift distribution inferred or otherwise determined from the air movement data 448 and its ideal lift distribution, the aircraft control logic 450 may determine one or more control inputs likely to achieve a lift distribution that is closer to ideal. As an example, the logic 450 may adjust a flight control surface or adjust a propulsion device (e.g., change the propeller speed of one or more propellers) to change an attitude or airspeed of the aircraft 10 so that the wing's actual lift distribution is more optimal. By continuing to monitor the wing's downwash, the aircraft control logic 450 may continue to make adjustments to provide more optimal lift distribution and, thus, more efficient flight as conditions change. In other embodiments, the aircraft control logic 450 may determine other types of parameters for assessing the aircraft's performance.

Note that the aircraft control logic 450 may calculate aerodynamic forces and force distributions, as well as other flight performance characteristics, dynamically in order to determine the appropriate control adjustments for the aircraft 10 to achieve more optimal performance. However, it is possible for calculations to be performed beforehand and for the system to store data correlating certain air movements (e.g., induced velocity), as indicated by the air movement data 448 for a wing's downwash, to desired control inputs for various operating conditions to achieve optimum performance. In such an embodiment, the aircraft control logic 450 may be configured to look up the appropriate control inputs based on the measured air movement and current operating conditions without actually performing real-time aerodynamic force calculations. Yet other changes and modifications are possible in other embodiments.

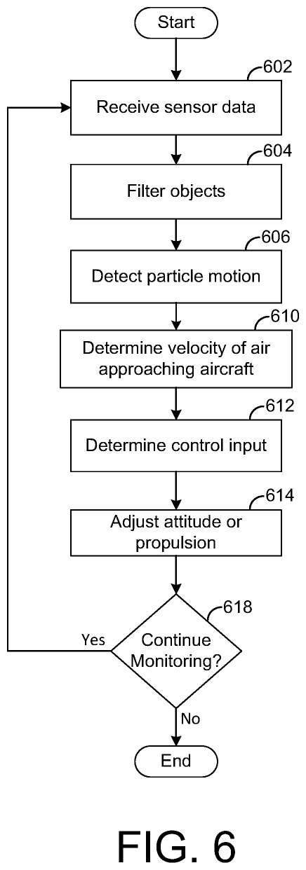

An exemplary use and operation of the system 205 in order to counteract air movement will be described in more detail below with reference to FIG. 6.

At step 602, one or more sensors 20, 30 may sense the space around aircraft 10 using LIDAR. The sensors 20, 30 may then provide sensor data indicative of the LIDAR data returns to data filter 250. Data filter 250 may receive sensor data from one or more sensors 20, 30, and the splitter 252 may split a data signal indicative of the sensor data into one or more paths. Thereafter, processing may continue to step 604.

At step 604, filters 254 and 256 may filter data indicative of objects or particles from the LIDAR sensor data before providing filtered sensor data to the aircraft controller 220 and sense and avoid element 207, respectively. Filter 254 may provide filtered sensor data indicative of small particles to the aircraft controller 220, and filter 256 may provide filtered sensor data indicative of relatively large objects to the sense and avoid element 207. After the aircraft controller 220 has received filtered sensor data from filter 256, processing may proceed to step 606.

At step 606, the aircraft control logic 450 may receive the filtered sensor data from data filter 250 and may detect particle motion within the sensor data. Aircraft control logic 450 may generate a three-dimensional map of the space around the aircraft 10, and may detect particle motion that is indicative of moving air based on sensor data as described above. Thereafter processing may proceed to step 610.

At step 610, aircraft control logic 450 may determine the velocity of air that is approaching the aircraft 10 based on the three-dimensional map derived from the sensor data. The logic 450 may then determine one or more control inputs (e.g., propulsion changes or actuations of flight control surfaces) for counteracting the air movement (e.g., a gust) at step 612. As an example, if the aircraft 10 is approaching an updraft, the logic 450 may determine to pitch the nose of the aircraft downward or decrease the speed of one or more propellers in an effort to reduce the effects of the updraft on movement of the aircraft 10. Thereafter processing may continue to step 614, where the aircraft control logic 450 may control the aircraft 10 by providing the control input determined at step 612 to counteract the effects of the air movement. At step 618, the aircraft control logic 450 determines whether monitoring is to continue. If so, processing may proceed to step 602.

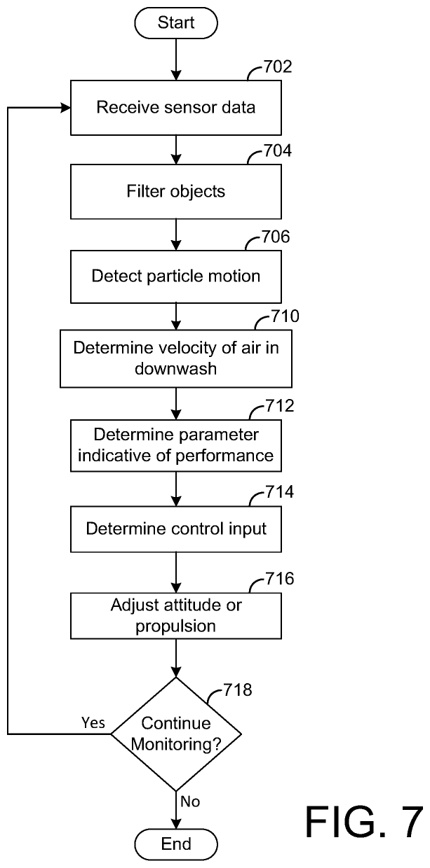

An exemplary use and operation of the system 205 in order to provide more optimal flight performance as the aircraft 10 travels will be described in more detail below with reference to FIG. 7.

At step 702, one or more sensors 20, 30 may sense the space around aircraft 10 using LIDAR. The sensors 20, 30 may then provide sensor data indicative of the LIDAR data returns to data filter 250. Data filter 250 may receive sensor data from one or more sensors 20, 30, and the splitter 252 may split a data signal indicative of the sensor data into one or more paths. Thereafter, processing may continue to step 704.

At step 704, filters 254 and 256 may filter data indicative of objects or particles from the LIDAR sensor data before providing filtered sensor data to the aircraft controller 220 and sense and avoid element 207, respectively. Filter 254 may provide filtered sensor data indicative of small particles to the aircraft controller 220, and filter 256 may provide filtered sensor data indicative of relatively large objects to the sense and avoid element 207. After the aircraft controller 220 has received filtered sensor data from filter 256, processing may proceed to step 706.

At step 706, the aircraft control logic 450 may receive the filtered sensor data from data filter 250 and may detect particle motion within the sensor data. Aircraft control logic 450 may generate a three-dimensional map of the space around the aircraft 10, and may detect particle motion that is indicative of moving air based on sensor data as described above. Thereafter processing may proceed to step 710.

At step 710, aircraft control logic 450 may determine the velocity of air in the downwash of at least one wing based on the three-dimensional map derived from the sensor data. As an example, the aircraft control logic 450 may measure induced velocity of the airflow passing over the wing. At step 712, the aircraft control logic 450 may estimate at least one parameter indicative of an aerodynamic performance of the wing based on the air velocity. As an example, the aircraft control logic 450 may estimate induced drag based on the induced velocity and then infer the lift distribution over the wing based on induced drag. In other examples, other types of parameters may be determined. At step 714, the logic 450 may determine one or more control inputs (e.g., propulsion changes or actuations of flight control surfaces) for enhancing wing performance based on the parameter determined at step 712. As an example, the aircraft control logic 450 may determine an ideal lift distribution for the wing based on the current operating conditions, such as altitude and airspeed, and determine a control input for making the current lift distribution more ideal. Thereafter processing may continue to step 716, where the aircraft control logic 450 may control the aircraft 10 by providing the control input determined at step 714 to enhance wing performance. At step 718, the aircraft control logic 450 determines whether monitoring is to continue. If so, processing may proceed to step 702.

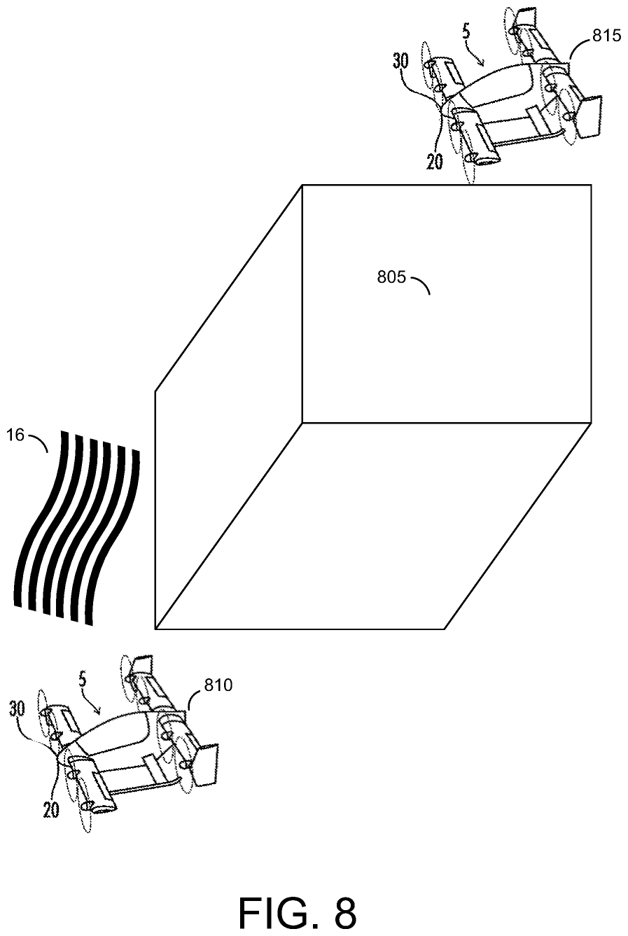

FIG. 8 depicts a three-dimensional perspective view of aircraft 810, 815 having aircraft monitoring systems operating in an urban environment in accordance with some embodiments of the present disclosure. Obstacle 805 is depicted as a tall building such as in an urban region, but can be various types of obstacles capable of obstructing an ability of sensors 20, 30 of an aircraft monitoring system 205 to sense air movement. Each of the aircraft 810, 815 has an aircraft monitoring system 205 for detecting air movement as described herein. Although only two aircraft 810, 815 are depicted in FIG. 8, various numbers of aircraft 810, 815 are possible in other embodiments, such as when hundreds or even thousands of aircraft 810, 815 may operate within the same region or urban location. As shown in FIG. 8, aircraft 810, 815 may operate in an urban environment with many obstacles such as tall buildings that prevent detection of air movement 816 (e.g., by obstructing a field of view of the sensors 20, 30). In this regard, an aircraft 815 may be unable to sense air movement 816 behind obstacles in advance, and may be negatively impacted by the air movement 816.

Each aircraft 810, 815 in FIG. 8 has an aircraft monitoring system 205 configured as described herein. The aircraft controller 220 of each aircraft 810, 815 (e.g., control logic 450) may generate a 3D map of space around its respective aircraft 810, 815 based on sensor data and may use the 3D map to identify air movement based on air movement data 448, as described above. Each aircraft 810, 815 may communicate or otherwise share 3D map data with the other aircraft 810, 815 to enable an aircraft monitoring system 205 to generate a larger 3D map indicative of data sensed by each respective aircraft 810, 815. In this regard, one aircraft 810, 815 may use 3D map data from the other aircraft 810, 815 in a different location to build a more complete map of the environment in which the aircraft 810, 815 is operating, such as by filling in gaps in a 3D map using data for the obstructed region sensed by another aircraft.

Note that information indicative of air movement 816 detected by aircraft of a fleet operating in an urban environment may be communicated to and stored in various locations, such as at a remote fleet controller (not specifically shown) or other aircraft of the fleet. In this regard, each aircraft of the fleet may communicate the sensed data (e.g., a 3D map generated by the aircraft's monitoring system) to the remote fleet controller (not specifically shown), other aircraft 810, 815, or otherwise. The information may be dynamically updated and communicated to the fleet controller and other fleet aircraft as new information is available to the fleet controller or fleet aircraft. Each aircraft of the fleet may perform similar sensing of air movement and sharing of the information with the fleet controller and other fleet aircraft. In addition, the fleet controller may communicate new information to aircraft of the fleet when received. In some embodiments, the fleet controller may provide information based on the location of an aircraft, such that information for regions where air movement is unlikely to affect flight of the aircraft may not be provided.

As an example, in the context of FIG. 8, each of aircraft 810 and 815 is depicted as aircraft of a fleet of aircraft operating in an urban area, where obstacle 805 is a tall building that obstructs sensors 20, 30 of aircraft 815 from sensing air movement 816. As described above, aircraft monitoring systems 205 for each of aircraft 810, 815 each may generate a 3D map based on data sensed by their respective sensors 20, 30. The 3D map generated by each aircraft 810, 815 may be communicated to the fleet controller, other fleet aircraft (e.g., aircraft 810, 815) or otherwise.

As aircraft 810 travels past the building 805, its sensors 20, 30 may sense the region where air movement 816 is located and provide sensor data for aircraft controller 220 to use for generating or updating a 3D map that includes sensor data indicative of the air movement 816. The controller 220 may communicate the sensor data (e.g., the 3D map) to the fleet controller and to other aircraft in the area, such as aircraft 815, which may not yet be able to sense or detect the air movement 816 because it is obstructed by building 805. Aircraft monitoring system 5 of aircraft 815 (e.g., aircraft controller 220) may receive the sensor data (e.g., from fleet controller, aircraft 810, or both) and use the sensor data provided by aircraft 810 that is indicative of the region where air movement 816 is occurring to detect the air movement 816 and make control decisions based on the presence of the air movement 816, as described herein.

The foregoing is merely illustrative of the principles of this disclosure and various modifications may be made by those skilled in the art without departing from the scope of this disclosure. The above described embodiments are presented for purposes of illustration and not of limitation. The present disclosure also can take many forms other than those explicitly described herein. Accordingly, it is emphasized that this disclosure is not limited to the explicitly disclosed methods, systems, and apparatuses, but is intended to include variations to and modifications thereof, which are within the spirit of the following claims.

As a further example, variations of apparatus or process parameters (e.g., dimensions, configurations, components, process step order, etc.) may be made to further optimize the provided structures, devices and methods, as shown and described herein. In any event, the structures and devices, as well as the associated methods, described herein have many applications. Therefore, the disclosed subject matter should not be limited to any single embodiment described herein, but rather should be construed in breadth and scope in accordance with the appended claims.

1-24. (canceled)

25. An aircraft monitoring system, comprising:
at least one optical sensor for sensing air movement external to an aircraft; and
an aircraft controller having at least one processor configured to control the aircraft based on the sensed air movement.

26. The system of claim 25, wherein the aircraft controller is configured to control a flight control system or a propulsion system of the aircraft based on the sensed air movement, thereby changing an attitude or velocity of the aircraft.

27. The system of claim 25, wherein the at least one optical sensor comprises a light detection and ranging (LIDAR) sensor.

28. The system of claim 25, wherein the at least one processor is configured to determine at least one parameter indicative of an aerodynamic performance of a wing of the aircraft, and wherein the at least one processor is further configured to control the aircraft based on the at least one parameter for enhancing the aerodynamic performance of the wing.

29. The system of claim 28, wherein the aircraft controller is configured to determine the at least one parameter based on a velocity of the air movement within a downwash of the wing.

30. The system of claim 28, wherein the at least one parameter is indicative of a lift distribution across the wing.

31. The system of claim 28, wherein the at least one parameter is induced drag.

32. The system of claim 28, wherein the aircraft controller is configured to determine a lift distribution across the wing based on the at least one parameter, and wherein the aircraft controller is further configured to control the aircraft based on the lift distribution.

33. The system of claim 25, wherein the at least one processor is configured to determine based on the sensed air movement at least one parameter indicative of a gust external to the aircraft, and wherein the at least one processor further configured to control the aircraft based on the at least one parameter for counteracting the gust.

34. The system of claim 33, wherein the at least one processor is configured to detect the gust prior to the aircraft reaching the gust.

35. The system of claim 33, wherein the at least one processor is configured to control the aircraft based on the at least one parameter to reduce a change in a path of the aircraft caused by the gust.

36. A method for monitoring an aircraft, comprising:
sensing, with at least one optical sensor on the aircraft, air movement external to the aircraft; and
controlling the aircraft with at least one processor based on the sensed air movement.

37. The method of claim 36, wherein the controlling comprises changing an attitude or velocity of the aircraft.

38. The method of claim 36, wherein the at least one optical sensor comprises a light detection and ranging (LIDAR) sensor.

39. The method of claim 36, further comprising determining, with the at least one processor based on the sensed air movement, at least one parameter indicative of a gust external to the aircraft, wherein the controlling is based on the at least one parameter.

40. The method of claim 39, wherein the determining occurs prior to the aircraft reaching the gust.

41. The method of claim 39, wherein the controlling comprises reducing a change in a path of the aircraft caused by the gust.

42. The method of claim 36, further comprising determining, with the at least one processor based on the sensed air movement, at least one parameter indicative of an aerodynamic performance of a wing of the aircraft, wherein the controlling is based on the at least one parameter.

43. The method of claim 42, wherein the determining is based on a velocity of the air movement within a downwash of the wing.

44. The method of claim 42, wherein the at least one parameter is indicative of a lift distribution across the wing.

45. The method of claim 42, wherein the at least one parameter is induced drag.

46. The method of claim 42, further comprising determining a lift distribution across the wing based on the at least one parameter, and wherein the controlling is based on the lift distribution.
